(19) United States
(12) Patent Application Publication
(10) Pub. No.: US 2026/0274582 A1
(43) Pub. Date: Sep. 17, 2026

(54) SOUND ATTENUATED ROLLER FOR CONVEYOR SYSTEM

(71) Applicant: Woodsage LLC, Holland, OH (US)

(72) Inventors: Adam Robert Webster, Toledo, OH (US); John Michael Joseph, Swanton, OH (US); Branden Hille, Elmore, OH (US); Mark Thomas Brown, Perrysburg, OH (US)

(73) Assignee: Woodsage LLC, Holland, OH (US)

(21) Appl. No.: 19/566,079

(22) Filed: Mar. 13, 2026

Related U.S. Application Data
(60) Provisional application No. 63/771,371, filed on Mar. 13, 2025.

(51) Int. Cl. B65G 39/07; B65G 13/00; B65G 39/09

(52) U.S. Cl. CPC B65G 39/07; B65G 13/00; B65G 39/09; B65G 2207/32

(57) ABSTRACT

A roller for a conveyor system is disclosed herein. The roller includes a cylindrical body, a first sleeve, and a second sleeve. The cylindrical body has an outer surface that includes a sleeve receiving surface. The first sleeve is formed from a sound damping material circumferentially coupled with a first portion of the sleeve receiving surface. The second sleeve is formed from a non-sound damping material circumferentially coupled with a second portion of the sleeve receiving surface. The first sleeve and the second sleeve form an uninterrupted surface.

### CROSS-REFERENCE TO RELATED APPLICATIONS

This application claims priority to U.S. Provisional Application No. 63/771,371, filed on Mar. 13, 2025, which is incorporated by reference in its entirety.

### FIELD OF THE DISCLOSURE

Embodiments disclosed herein generally related to a roller for a conveyor system, and, more specifically, a sound attenuated roller for a conveyor system.

### BACKGROUND

Conveyor systems are essential for efficient material handling across industries. They typically include a continuous a moving platform that transports goods from one end of the conveyor system to the other end of the conveyor system to reduce the manual labor involved in the process. One of the key components of conveyor systems is the conveyor roller, which supports and guides the conveyor belt or carried materials.

### SUMMARY

In some embodiments, a roller for a conveyor system is disclosed herein. The roller includes a cylindrical body, a first sleeve, and a second sleeve. The cylindrical body has an outer surface that includes a sleeve receiving surface. The first sleeve is formed from a sound damping material circumferentially coupled with a first portion of the sleeve receiving surface. The second sleeve is formed from a non-sound damping material circumferentially coupled with a second portion of the sleeve receiving surface. The first sleeve and the second sleeve form an uninterrupted surface.

In some embodiments, a conveyor system is disclosed herein. The conveyor system includes a first side wall, a second side wall, and a roller extending between the first side wall and the second side wall. The roller includes a cylindrical body, a first sleeve, and a second sleeve. The cylindrical body has an outer surface that includes a sleeve receiving surface. The first sleeve is formed from a sound damping material circumferentially coupled with a first portion of the sleeve receiving surface. The second sleeve is formed from a non-sound damping material circumferentially coupled with a second portion of the sleeve receiving surface. The first sleeve and the second sleeve form an uninterrupted surface.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a perspective view of a roller for a conveyor system, according to example embodiments.

FIG. 1B is an exploded view of the roller of FIG. 1A, according to example embodiments.

FIG. 1C is a cross-sectional side view of the roller of FIGS. 1A-1B, according to example embodiments.

FIG. 1D is a side longitudinal view of the roller of FIG. 1C, according to example embodiments.

FIG. 2A is a perspective view of a roller for a conveyor system, according to example embodiments.

FIG. 2B is a side view of the roller of FIG. 2A, according to example embodiments.

FIG. 2C is a partial cross-sectional side view of the roller of FIG. 2B, according to example embodiments.

FIG. 3 is a top view of a conveyor having a roller installed therein, according to example embodiments.

To facilitate understanding, identical reference numerals have been used, where possible, to designate identical elements that are common to the figures. It is contemplated that elements disclosed in an embodiment may be beneficially utilized on other embodiments without specific recitation.

### DETAILED DESCRIPTION

One or more embodiments disclosed herein generally relate to a roller for a conveyor system and, more specifically, a sound attenuated roller for a conveyor system. In particular, one or more techniques disclosed herein provide a roller that includes two sleeves coupled to a cylindrical body of the roller: a first sleeve formed from a sound damping material and a second sleeve formed from a non-sound damping material. Collectively, the outer surfaces of the first sleeve and the second sleeve form an uninterrupted outer surface of the conveyor roller. In some embodiments, the cylindrical body of the roller may be substantially uniform from a first end to a second end of the cylindrical body. For example, in some embodiments, the cylindrical body may include a constant radius from the first end to the second end. In some embodiments, the cylindrical body may include one or more grooves formed therein. The one or more grooves may allow for placement of the roller in both belt-drives conveyor systems and non-belt driven conveyor systems.

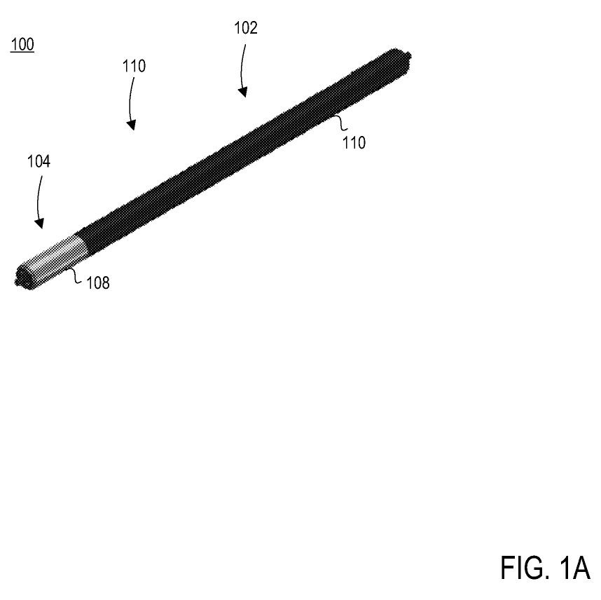

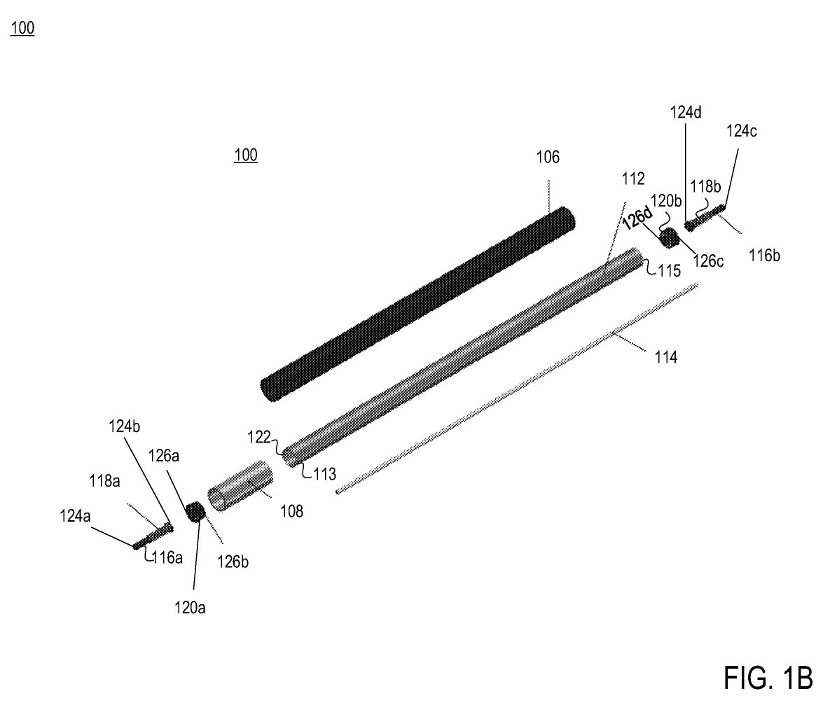

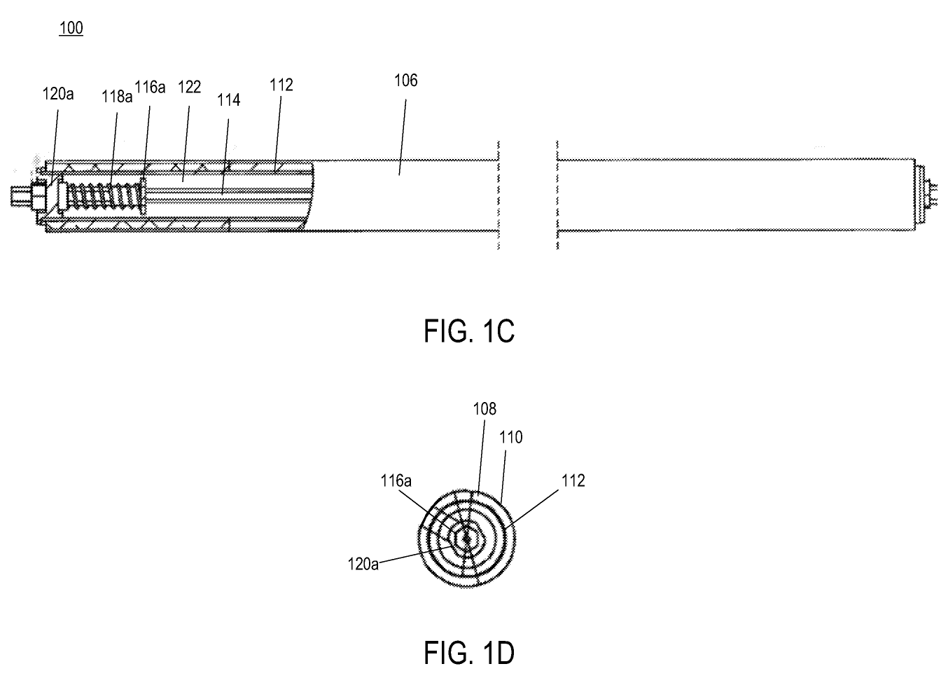

FIGS. 1A-1D illustrate various views of roller 100 for use with a conveyor assembly according to example embodiments.

Roller 100 may include a cylindrical body 112, an axle 114, end connectors 116a-116b, biasing mechanism 118a-118b, and bearing 120a-120b. Cylindrical body 112 may be formed from a variety of metal materials, such as, but not limited to galvanized steel. Cylindrical body 112 may have a first diameter. Cylindrical body 112 may further include an axial opening 122 formed in the cylindrical body 112, extending from a first end 113 of cylindrical body 112 to a second end 115 of cylindrical body 112.

Axle 114 may be disposed within axial opening 122 of cylindrical body 112. Axle 114 may be secured within axial opening 122 via end connectors 116a-116b, biasing mechanisms 118a-118b, and bearings 120a-120b. For example, as shown in FIGS. 1B-1C, end connector 116a and bearing 120a may be disposed at least partially in axial opening 122 at first end 113 of cylindrical body 112. End connector 116a may include a first end 124a and a second end 124b. Similarly, bearing 120a may include a first end 126a and a second end 126b. First end 124a of end connector 116a may be configured to extend through an opening formed in bearing 120a, such that end connector 116a extends from second end 126b of bearing 120a to first end 126a of bearing 120a. Biasing mechanism 118a may be disposed around at least a portion of end connector 116a. For example, as shown, biasing mechanism 118a may be at least partially disposed around end connector 116a. Axle 114 may be configured to interface with second end 124b of end connector 116a. When positioned in a conveyor, first end 124a of end connector 116a may be configured to interface with or connect to side walls of the conveyor to secure roller 100 to the conveyor. In some embodiments, end connector 116a may be representative of a hexagonally shaped end connector to interface with hexagonal openings of the conveyor. End connector 116a may operably connect roller 100 to side walls of conveyor such that roller 100 is rotatable around its longitudinal axis.

A similar arrangement of elements may exist at second end 115 of cylindrical body 112. In particular, end connector 116b and bearing 120b may be disposed at least partially in axial opening 122 at second end 115 of cylindrical body 112. End connector 116b may include a first end 124c and a second end 124d. Similarly, bearing 120b may include a first end 126c and a second end 126d. First end 124c of end connector 116b may be configured to extend through an opening formed in bearing 120b, such that end connector 116b extends from second end 126d of bearing 120b to first end 126c of bearing 120b. Biasing mechanism 118b may be disposed around at least a portion of end connector 116b. For example, as shown, biasing mechanism 118b may be at least partially disposed around end connector 116b. Axle 114 may be configured to interface with second end 124d of end connector 116b. When positioned in a conveyor, second end 124d of end connector 116b may be configured to interface with or connect to side walls of the conveyor to secure roller 100 to the conveyor. In some embodiments, end connector 116b may be representative of a hexagonally shaped end connector to interface with hexagonal openings of the conveyor. End connector 116b may operably connect roller 100 to side walls of conveyor such that roller 100 is rotatable around its longitudinal axis.

Biasing mechanism 118a and biasing mechanism 118b may exert compressive force against bearings 120a, 120b and axle 114 to maintain the positioning of axle 114 within axial opening 122.

As shown, roller 100 includes a damped portion 102 and an undamped portion 104. For example, as better illustrated in FIGS. 1A-1B, damped portion 102 may include a first sleeve 106 positioned thereon. First sleeve 106 may be configured to reduce or dampen the sound of roller 100 when in use with a conveyor assembly. In some embodiments, first sleeve 106 may be formed from a material that dampens or reduces sound, such as, a material that falls within the range of 40A-60A durometer. Undamped portion 104 may include a second sleeve 108 positioned thereon. Second sleeve 108 may be representative of an undamped material, such as a metal material (e.g., aluminum). First sleeve 106 and second sleeve 108 may collectively define an outer surface 110 configured to interface with objects when installed in a conveyor system. Each of first sleeve 106 and second sleeve 108 may have the same sized radius, such that, when positioned over cylindrical body 112, the overall radius along roller 100 at first sleeve 106 and second sleeve 108 is uniform.

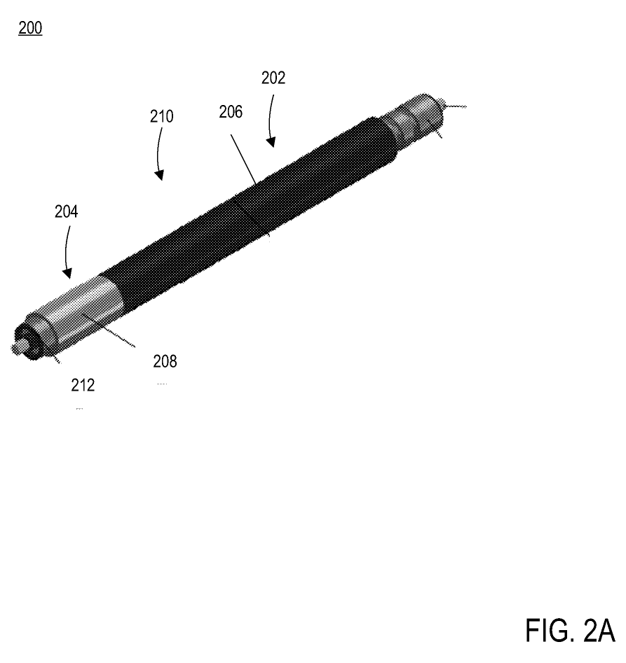

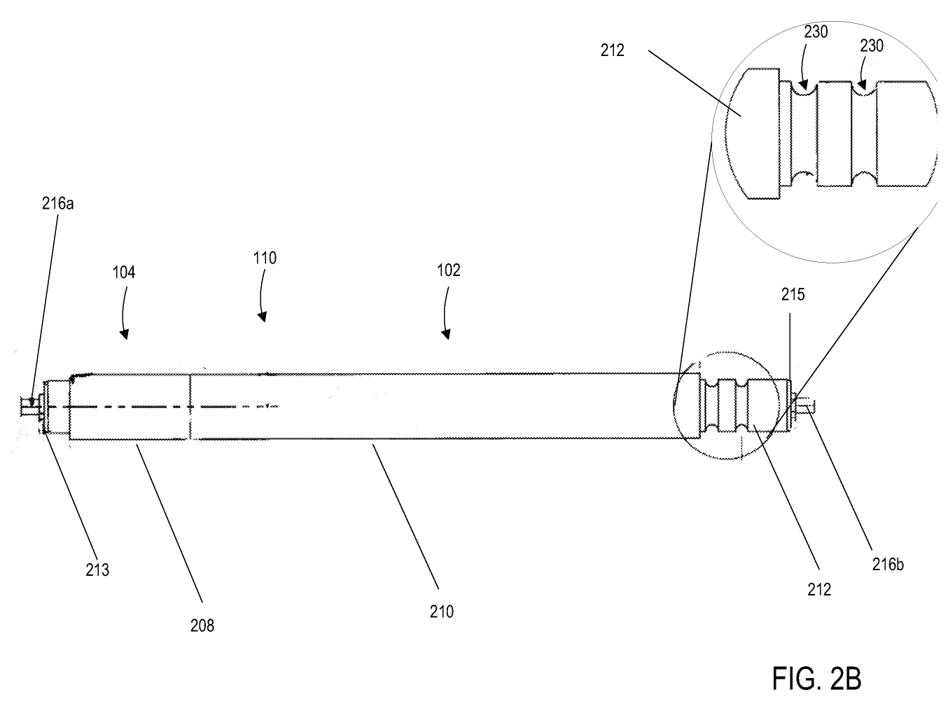

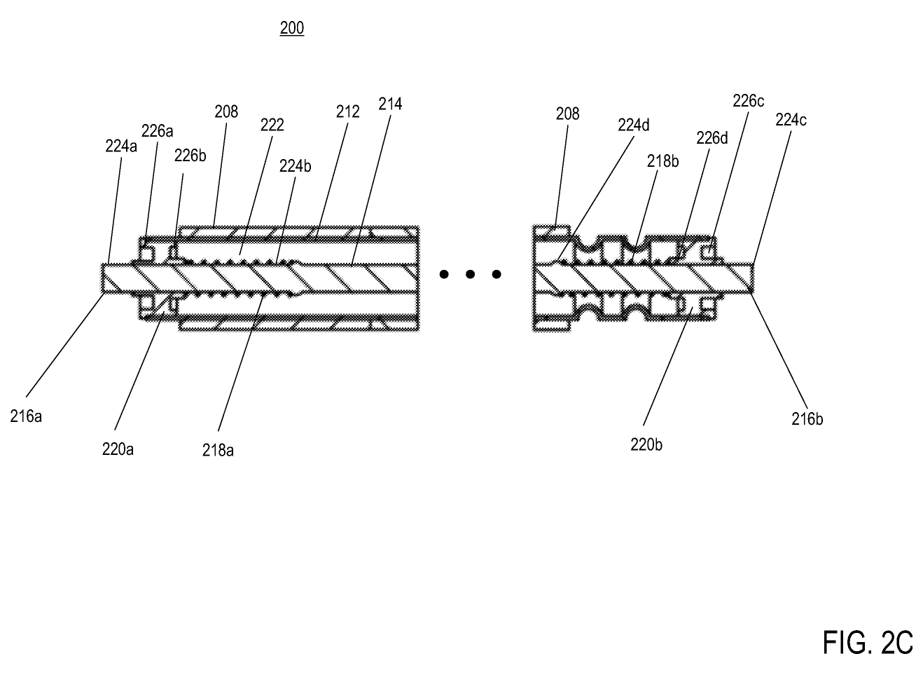

FIGS. 2A-2C illustrates a roller 200, according to example embodiments. Roller 200 is substantially similar to roller 100 in that roller 200 includes a damped portion 202 having a first sleeve 206 and an undamped portion 204 having a second sleeve 208. Roller 200 differs from roller 100 in that roller 200 may include a non-uniform cylindrical body 212. For example, as shown, roller 200 may include a cylindrical body 212, an axle 214, end connectors 216a-216b, biasing mechanism 218a-218b, and bearing 220a-220b. Cylindrical body 212 may be formed from a variety of metal materials, such as, but not limited to galvanized steel. Cylindrical body 212 may include an axial opening 222 formed in the cylindrical body 212, extending from a first end 213 of cylindrical body 212 to a second end 215 of cylindrical body 212. As shown, second end 215 of cylindrical body 212 may include one or more grooves 230 formed therein. The one or more grooves 230 may allow for roller 200 to be used with belt-driven conveyor systems.

Axle 214 may be disposed within axial opening 222 of cylindrical body 212. Axle 214 may be secured within axial opening 222 via end connectors 216a-216b, biasing mechanisms 218a-218b, and bearings 220a-220b. For example, as shown in FIGS. 1B-1C, end connector 216a and bearing 220a may be disposed at least partially in axial opening 222 at first end 213 of cylindrical body 212. End connector 216a may include a first end 224a and a second end 224b. Similarly, bearing 220a may include a first end 226a and a second end 226b. First end 224a of end connector 216a may be configured to extend through an opening formed in bearing 220a, such that end connector 216a extends from first end 226a of bearing 220a to second end 226b of bearing 220a. Biasing mechanism 218a may be disposed around at least a portion of end connector 116a. For example, as shown, biasing mechanism 218a may be at least partially disposed around end connector 216a on second end 224b of end connector 116a. Axle 214 may be configured to interface with second end 224b of end connector 216a. When positioned in a conveyor, first end 224a of end connector 216a may be configured to interface with or connect to side walls of the conveyor to secure roller 200 to the conveyor. In some embodiments, end connector 116a may be representative of a hexagonally shaped end connector to interface with hexagonal openings of the conveyor. End connector 216a may operably connect roller 200 to side walls of conveyor such that roller 200 is rotatable around its longitudinal axis.

A similar arrangement of elements may exist at second end 215 of cylindrical body 212. In particular, end connector 216b and bearing 220b may be disposed at least partially in axial opening 222 at second end 215 of cylindrical body 212. End connector 216b may include a first end 224c and a second end 224d. Similarly, bearing 220b may include a first end 226c and a second end 226d. First end 224c of end connector 216b may be configured to extend through an opening formed in bearing 220b, such that end connector 216b extends from first end 226c of bearing 220b to second end 226d of bearing 220b. Biasing mechanism 218b may be disposed around at least a portion of end connector 216b. For example, as shown, biasing mechanism 218b may be at least partially disposed around end connector 216b on second end 224d of end connector 216b. Axle 214 may be configured to interface with second end 224d of end connector 216b. When positioned in a conveyor, second end 224d of end connector 216b may be configured to interface with or connect to side walls of the conveyor to secure roller 200 to the conveyor. In some embodiments, end connector 216b may be representative of a hexagonally shaped end connector to interface with hexagonal openings of the conveyor. End connector 216b may operably connect roller 200 to side walls of conveyor such that roller 200 is rotatable around its longitudinal axis.

Similar to roller 100, first sleeve 206 and second sleeve 208 may collectively define an uninterrupted outer surface 210 configured to interface with objects when installed in a conveyor system. Each of first sleeve 206 and second sleeve 208 may have the same sized radius, such that, when positioned over cylindrical body 212, the overall radius along roller 200 at first sleeve 206 and second sleeve 208 is uniform.

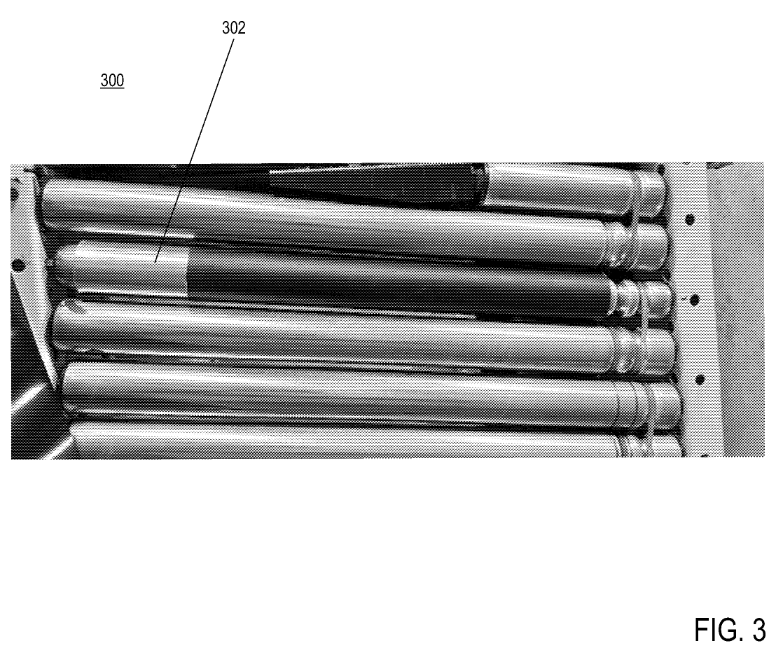

FIG. 3 is a top view of a conveyor 300 having a roller 302 installed therein, according to example embodiments. As shown, conveyor 300 includes a plurality of rollers coupled to sidewalls of conveyor 300. One of the plurality of rollers is roller 302. Roller 302 is representative of roller 200 discussed above in conjunction with FIGS. A-B. Roller 302 may be similarly coupled with sidewalls of conveyor 300 via its end connectors. Furthermore, as shown, belts of conveyor 300 are shown interfacing with the grooves formed in roller 302.

Additional examples of the presently described method and device embodiments are suggested according to the structures and techniques described herein. Other non-limiting examples may be configured to operate separately or may be combined in any permutation or combination with any one or more of the other examples provided above or throughout the present disclosure.

It will be appreciated by those skilled in the art that the present disclosure may be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language "means for" or "step for" be interpreted under 35 U.S.C. 112(f). Claims that do not expressly include the phrase "means for" or "step for" are not to be interpreted under 35 U.S.C. 112(f).

1. A roller for a conveyor system, comprising:
a cylindrical body having an outer surface, the outer surface comprising a sleeve receiving surface;
a first sleeve formed from a sound damping material circumferentially coupled with a first portion of the sleeve receiving surface; and
a second sleeve formed from a non-sound damping material circumferentially coupled with a second portion of the sleeve receiving surface, the first sleeve and the second sleeve forming an uninterrupted surface.

2. The roller of claim 1, wherein the cylindrical body comprises a radius that is constant from a first end of the cylindrical body to a second end of the cylindrical body.

3. The roller of claim 2, wherein the first sleeve has a second radius larger than the radius of the cylindrical body and the second sleeve has a third radius equal to the second radius.

4. The roller of claim 1, wherein the cylindrical body comprises:
a first end extending past the first sleeve and the second sleeve; and
a second end opposite the first end, the second end extending past the first sleeve and the second sleeve, the second end comprising one or more grooves formed therein.

5. The roller of claim 1, wherein the sound damping material is formed from a material having a hardness in a range of 40A-60A durometer.

6. The roller of claim 1, wherein the cylindrical body defines an axial opening and the roller further comprises:
an axle disposed in the axial opening.

7. The roller of claim 6, further comprising:
a first bearing at least partially disposed in a first side of the axial opening;
a first end connector configured to interface with the axle and the first bearing; and
a first biasing mechanism positioned about the first end connector.

8. The roller of claim 7, further comprising:
a second bearing at least partially disposed in a second side of the axial opening;
a second end connector configured to interface with the axle and the second bearing; and
a second biasing mechanism positioned about the second end connector.

9. The roller of claim 8, wherein the first biasing mechanism and the second biasing mechanism are configured to exert a compressive force against the first bearing, the second bearing to maintain a positioning of the axle within the axial opening.

10. The roller of claim 8, wherein the first end connector and the second end connector are configured to interface with side walls of the conveyor system.

11. A conveyor system, comprising:
a first side wall;
a second side wall; and
a roller extending between the first side wall and the second side wall, the roller comprising:
a cylindrical body having an outer surface, the outer surface comprising a sleeve receiving surface;
a first sleeve formed from a sound damping material circumferentially coupled with a first portion of the sleeve receiving surface; and
a second sleeve formed from a non-sound damping material circumferentially coupled with a second portion of the sleeve receiving surface, the first sleeve and the second sleeve forming an uninterrupted surface.

12. The conveyor system of claim 11, wherein the cylindrical body comprises a radius that is constant from a first end of the cylindrical body to a second end of the cylindrical body.

13. The conveyor system of claim 12, wherein the first sleeve has a second radius larger than the radius of the cylindrical body and the second sleeve has a third radius equal to the second radius.

14. The conveyor system of claim 11, wherein the cylindrical body comprises:
a first end extending past the first sleeve and the second sleeve; and
a second end opposite the first end, the second end extending past the first sleeve and he second sleeve, the second end comprising one or more grooves formed therein.

15. The conveyor system of claim 11, wherein the sound damping material is formed from a material having a hardness in a range of 40A-60A durometer.

16. The conveyor system of claim 11, wherein the cylindrical body defines an axial opening and the roller further comprises:
an axle disposed in the axial opening.

17. The conveyor system of claim 16, wherein the roller further comprises:
a first bearing at least partially disposed in a first side of the axial opening;
a first end connector configured to interface with the axle and the first bearing; and
a first biasing mechanism positioned about the first end connector.

18. The conveyor system of claim 17, wherein the roller further comprises:
a second bearing at least partially disposed in a second side of the axial opening;
a second end connector configured to interface with the axle and the second bearing; and
a second biasing mechanism positioned about the second end connector.

19. The conveyor system of claim 18, wherein the first biasing mechanism and the second biasing mechanism are configured to exert a compressive force against the first bearing, the second bearing to maintain a positioning of the axle within the axial opening.

20. The conveyor system of claim 18, wherein the first end connector and the second end connector are configured to interface with the first side wall and the second side wall.
